(19) United States
(12) Patent Application Publication
(10) Pub. No.: US 2011/0208556 A1
(43) Pub. Date: Aug. 25, 2011

(54) WORKER ASSIGNMENT DEVICE, WORKER ASSIGNMENT PROGRAM, AND WORKER ASSIGNMENT SYSTEM

(76) Inventors: Satoshi NAGAHARA, Yokohama (JP); Yoichi Nonaka, Yokohama (JP); Hisaya Ishibashi, Yokohama (JP); Takahiro Nakano, Fujisawa (JP)

(21) Appl. No.: 13/034,315

(22) Filed: Feb. 24, 2011

(30) Foreign Application Priority Data
Feb. 24, 2010 (JP) 2010-038097
Jan. 19, 2011 (JP) 2011-008388

(51) Int. Cl. G06Q 10/00

(52) U.S. Cl. 705/7.14; 705/7.15

(57) ABSTRACT

The present invention provides product delivery deadline compliance and increased worker training efficiency. A worker assignment scheme creation section of a worker assignment device creates a worker assignment scheme and calculates a job completion time for each process step of each product in accordance with a worker assignment rule. An evaluation value calculation section calculates evaluation values concerning delivery deadline compliance and worker training in accordance with processing results produced by the worker assignment scheme creation section. A worker assignment priority change section changes the worker assignment rule in accordance with the evaluation values and target values therefor. The above process is repeated a number of times to produce plural worker assignment schemes, which are compared in accordance with the evaluation values concerning delivery deadline compliance and worker training. The result of comparison is eventually presented to a user.

### RELATED APPLICATIONS

These applications relate to and claim priority from Japanese Patent Application No. 2010-038097, filed on Feb. 24, 2010 and No. 2011-008388, filed on Jan. 19, 2011. The entirety of the contents and subject matter of all of the above is incorporated herein by reference.

### BACKGROUND OF THE INVENTION

(1) Field of the Invention

The present invention relates to a technology for assigning workers to various jobs involved in a manufacturing process.

(2) Description of the Related Art

A technology for properly assigning workers to various jobs involved in a manufacturing process, which is attended by the workers, for the purpose of achieving production goals such as a target production volume and a customer's delivery deadline has been developed (refer, for instance, to JP-A No. H7-296062).

In recent years, a multi-product manufacturing scheme for manufacturing different types of products in a single manufacturing line has been commonly employed to meet diversified customer needs. For multi-product manufacturing, cross-trained workers are needed to handle machining procedures and facilities that vary from one product type to another. It is therefore necessary that the workers be trained for the development of their skills. When the skills of the workers are to be developed, it is necessary to preferentially assign the workers to jobs with which they are unfamiliar until they engage themselves with the unfamiliar jobs for a target period of time and gain sufficient experience in compliance with a training goal. However, inexperienced workers generally have to work for a longer period of time to finish their job than experienced ones. Therefore, if the inexperienced workers are preferentially assigned to the unfamiliar jobs, it might be difficult to achieve a production goal. Under these circumstances, worker assignment technologies for achieving both a production goal and a worker training goal have recently been developed.

A worker assignment technology described, for instance, in JP-A No. 2007-293690 calculates cycle time from a product-specific shipment plan concerning a multi-product manufacturing process, integrates element jobs without exceeding the cycle time in accordance with standard working time required for the completion of the element jobs, and not only achieves a target production volume but also maximizes the period of time of engagement in an unfamiliar job by assigning specific jobs to workers in such a manner that the total working time required for the integrated element jobs is maximized but shorter than the cycle time.

### SUMMARY OF THE INVENTION

In mass production, the same product is handled in each process step of a manufacturing process. Therefore, mass production can be effectively managed by controlling the working time for each process step of the manufacturing process in accordance with product cycle time, which is calculated from a target production volume. On the other hand, as regards make-to-order products, such as industrial machihes and motors, the delivery deadline and product specifications vary from one order to another. Unlike mass-produced products, the same delivery deadline and specifications are applied to only one or several units of make-to-order products. Therefore, when make-to-order products are to be manufactured, various process steps of their manufacturing process handle different products. Thus, the cycle time for each product cannot be calculated from a target production volume. Consequently, a worker assignment method based on cycle time, which is described, for instance, in JP-A No. 2007-293690, cannot be applied to the manufacture of make-to-order products.

The present invention has been made in view of the above circumstances, and provides a worker assignment technology that relates to a manufacturing process for which specifications and delivery deadline are set on an individual product basis and complies with both the delivery deadline and a worker training goal.

To address the problems described earlier, the present invention selectively uses an appropriate worker assignment scheme depending on whether priority is given to the compliance with a delivery deadline or the training of workers. When priority is given to the compliance with a delivery deadline, the present invention preferentially assigns workers who complete a relevant job in a relatively short period of time. When, on the other hand, priority is given to the training of workers, the present invention preferentially assigns workers who complete a relevant job in a relatively long period of time. The present invention then repeatedly changes the worker assignment scheme in the manner described above, compares and evaluates obtained worker assignment results from the viewpoints of delivery deadline compliance and worker training, presents the results of evaluation to a user, and creates a worker assignment scheme that complies with both the delivery deadline and worker training goal.

According to one aspect of the present invention, there is provided a worker assignment device that assigns workers to various jobs involved in a manufacturing process. The worker assignment device includes a storage, a controller, a display, an input section, and a communication section. The storage includes areas for storing product information that identifies a product, a delivery deadline for the product, and a process path for manufacturing the product; process path information that identifies a process path and process steps involved in the process path; in-progress process information that identifies a product, a process step currently applied to the product, and a state of the product in the process step such as waiting for processing or processing in progress; worker information that identifies a worker and the working hours of the worker; working time information that identifies a product, a process step for the product, a worker, and the working time required for the worker to complete the process step; training target time information that identifies a worker, a process step, and training target engagement time for the worker in the process step; processing priority information that identifies a product, a process step for the product, and the priority of the process step for the product; assignment priority information that identifies a product, a process step for the product, and the priority of a worker to be assigned to the process step; parameter information that identifies a delivery deadline compliance percentage target value, a training goal achievement percentage target value, an assignment start time, a time step, and an assignment priority change maximum repetition count; and work history information that identifies a product, a process step, a worker assigned to the process step for the product, and the job start time and job completion time for the process step for the product. The controller includes an information acquisition section that acquires information from the storage; a worker assignment scheme creation section that creates a worker assignment scheme for various process steps for the product in accordance with the product information, process path information, work result information, worker information, working time information, processing priority information, and assignment priority information and calculating the job start time and job completion time; a work history information storage section that stores worker assignment information created by the worker assignment scheme creation section and job start time information and job completion time information calculated by the worker assignment scheme creation section as the work history information in the storage; an evaluation value calculation section that performs a process for calculating the delivery deadline compliance percentage by dividing the number of products whose job completion time is before the delivery deadline by the total number of products in accordance with the job completion time information and order reception information and a process for calculating the percentage of training goal achievement concerning a specific process step of a specific worker by dividing the worker's work engagement time for the process step by target work engagement time for the process step of the worker in accordance with the worker assignment information, job start time information, job completion time information, and training target engagement time; and a worker assignment priority change section that performs, in accordance with the delivery deadline compliance percentage information, training goal achievement percentage information, working time information, and assignment priority information, a process for preferentially assigning workers whose working time is shorter than the working time of workers assigned to the process step for the purpose of increasing the delivery deadline compliance percentage, a process for preferentially assigning workers whose working time is longer than the working time of workers assigned to the process step for the purpose of increasing the training goal achievement percentage, and a process for recording the changed assignment priority as the assignment priority information. The display performs a process for simultaneously displaying the delivery deadline compliance percentage and training goal achievement percentage, which are the results of processing performed by the controller. The input section includes an area that allows a user of the worker assignment device to enter the parameter information. The communication section performs a process for exchanging information with peripheral devices such as an order reception processing device, a production planning device, and a production line management device.

The present invention enables the user of the worker assignment device to compare two or more worker assignment schemes from the viewpoints of delivery deadline compliance and worker training, select the best worker assignment scheme, and create a worker assignment scheme that achieves a high delivery deadline compliance percentage and a high worker training goal achievement percentage.

### BRIEF DESCRIPTION OF THE DRAWINGS

Embodiments of the present invention will be described in detail based on the following figures, wherein:

FIG. 1 is a functional block diagram illustrating a worker assignment device;

FIG. 2 is a schematic diagram illustrating a worker assignment system;

FIG. 3 is a schematic diagram illustrating an example of a manufacturing process;

FIG. 4 is a schematic diagram illustrating a product information table;

FIG. 5 is a schematic diagram illustrating a process path information table;

FIG. 6 is a schematic diagram illustrating an in-progress process step information table;

FIG. 7 is a schematic diagram illustrating a worker information table;

FIG. 8 is a schematic diagram illustrating a working time information table;

FIG. 9 is a schematic diagram illustrating a training target time information table;

FIG. 10 is a schematic diagram illustrating a processing priority information table;

FIG. 11 is a schematic diagram illustrating an assignment priority information table;

FIG. 12 is a schematic diagram illustrating a parameter information table;

FIG. 13 is a schematic diagram illustrating a work history information table;

FIG. 14 is a schematic diagram illustrating a computer;

FIG. 15 is a flowchart illustrating a process for creating a worker assignment scheme that complies with a delivery deadline and provides effective worker training;

FIG. 16 is a flowchart illustrating a process for calculating the job start time and job completion time of each process step of each product;

FIG. 17 is a flowchart illustrating a process for creating a worker assignment scheme for each process step of each product;

FIG. 18 is a flowchart illustrating a process for applying assignment priority changes to increase the percentage of delivery deadline compliance;

FIG. 19 is a flowchart illustrating a process for applying assignment priority changes to increase the percentage of training goal achievement;

FIG. 20 is a first schematic diagram illustrating an exemplary display screen;

FIG. 21 is a second schematic diagram illustrating another exemplary display screen;

FIG. 22 is a third schematic diagram illustrating another exemplary display screen;

FIG. 23 is a fourth schematic diagram illustrating another exemplary display screen; and

FIG. 24 is a fifth schematic diagram illustrating a still another exemplary display screen.

### DETAILED DESCRIPTION OF THE INVENTION

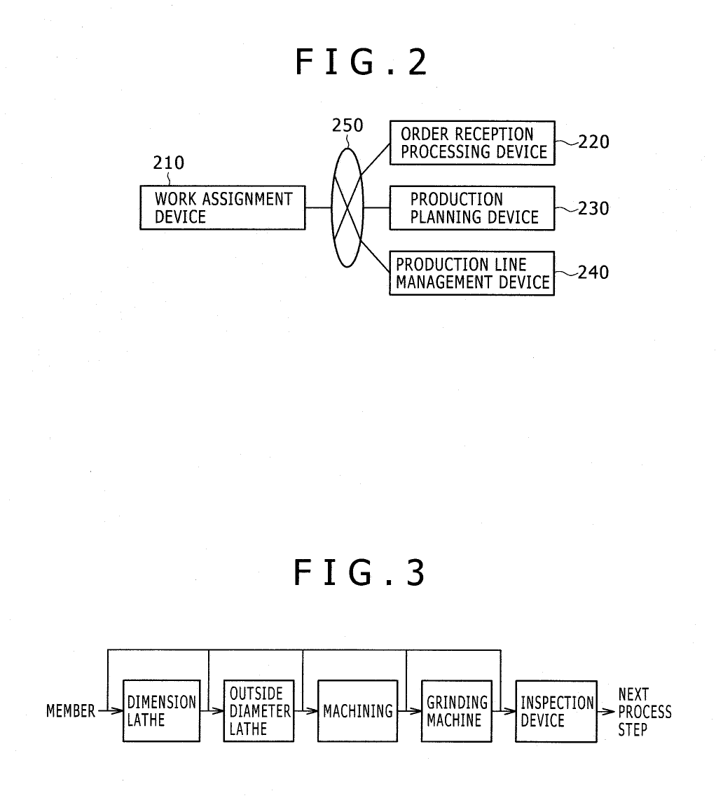

FIG. 2 is a schematic diagram illustrating a worker assignment system according to an embodiment of the present invention. As shown in FIG. 2, the worker assignment system includes a worker assignment device 210, an order reception processing device 220, a production planning device 230, and a production line management device 240. All of these system components can mutually exchange information through a network 250.

The present invention relates to worker assignment for a manufacturing process in which a product-specific delivery deadline is set as for the manufacture of make-to-order products such as industrial machines and motors and the working time varies with the skills of workers. For example, the present invention can be applied to a machining line for the shafts of industrial motors as shown in FIG. 3. As the industrial motors vary in size and machined form depending on the purpose of use, their process path varies from one product to another. In a target machining line, some products pass through the same process step a number of times, while the other products skip certain process steps. Further, the working time for each process step varies from one product to another. The working time also varies with the skills of workers engaged in a manufacturing process. The worker assignment system according to an embodiment of the present invention creates a worker assignment scheme for each process step of each product in a machining line and presents the created worker assignment scheme to a user.

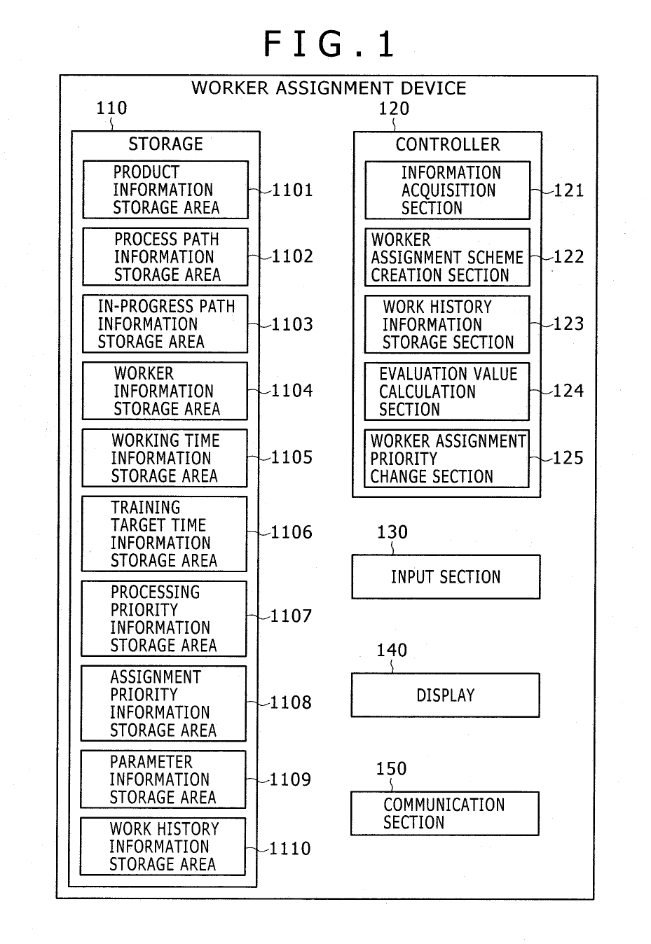

FIG. 1 is a functional block diagram illustrating the worker assignment device 210. As shown in FIG. 1, the worker assignment device 210 includes a storage 110, a controller 120, an input section 130, a display 140, and a communication section 150.

The storage 110 includes a product information storage area 1101, a process path information storage area 1102, an in-progress process information storage area 1103, a worker information storage area 1104, a working tithe information storage area 1105, a training target time information storage area 1106, a processing priority information storage area 1107, an assignment priority information storage area 1108, a parameter information storage area 1109, and a work history information storage area 1110.

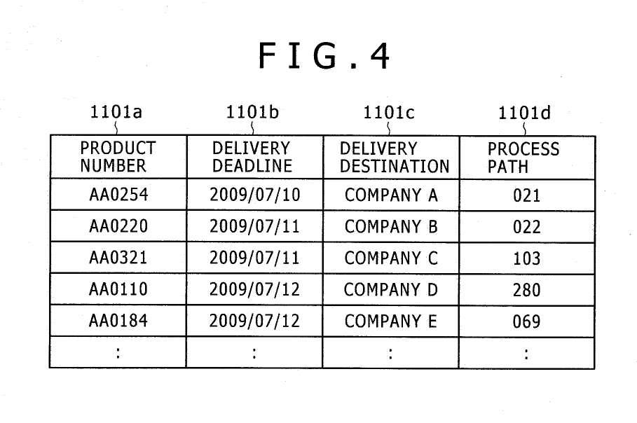

The product information storage area 1101 stores product information that identifies the delivery deadline and the process path for each product. In the present embodiment, for example, the product information storage area 1101 stores a product information table shown in FIG. 4. As shown in FIG. 4, the product information table has a product number column 1101a, a delivery deadline column 1101b, a delivery destination column 1101c, and a process path column 1101d. The product number column 1101a stores identification information that uniquely identifies a product. The delivery deadline column 1101b stores information that identifies the delivery deadline for the product identified by the product number column 1101a. In the table shown in FIG. 4, a date indicating the delivery deadline is identified in year/month/day form. However, the date indicated in the delivery deadline column 1101b is not limited to the year/month/day form. The delivery destination column 1101c stores information that identifies a delivery destination to which the product identified by the product number column 1101a is to be delivered. The process path column 1101d stores information that identifies a process path for the product identified by the product number column 1101a. In the table shown in FIG. 4, a process path number uniquely assigned to each process path is stored as process path identification information.

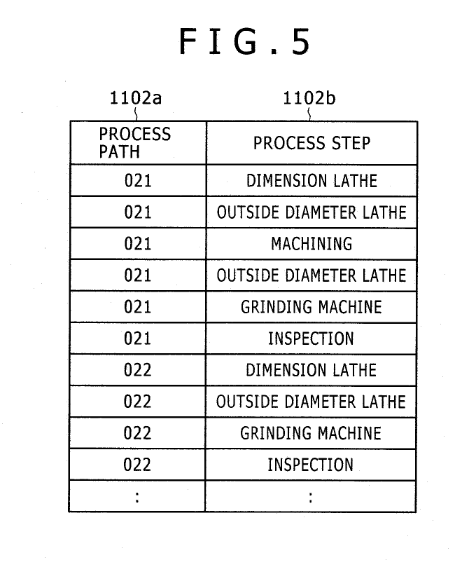

Returning to FIG. 1, the process path information storage area 1102 stores process path information that identifies a process step included in a process path. In the present embodiment, for example, the process path information storage area 1102 stores a process path information table shown in FIG. 5. As shown in FIG. 5, the process path information table has a process path column 1102a and a process step column 1102b. The process path column 1102a stores information that identifies each process path. The process step column 1102b stores information that identifies a process step included in the process path identified by the process path column 1102a. Records of process steps included in each process path are sequentially processed in order from the top to the bottom.

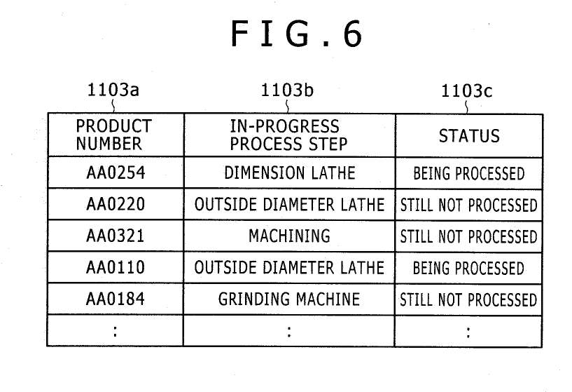

Returning to FIG. 1, the in-progress process information storage area 1103 stores in-progress process information that identifies an in-progress process of each product and the status (e.g., processing in progress or before processing) of the in-progress process. In the present embodiment, for example, the in-progress process information storage area 1103 stores an in-progress process step information table shown in FIG. 6. As shown in FIG. 6, the in-progress process step information table has a product number column 1103a, an in-progress process step column 1103b, and a status column 1103c. The product number column 1103a stores information that identifies a product. The in-progress process step column 1103b stores information that identifies an in-progress process for the product identified by the product number column 1103a. The status column 1103c stores information that identifies the status of the product identified by the product number column 1103a, or more specifically, indicates whether the product is being processed in the in-progress process step or is still not processed in the in-progress process step.

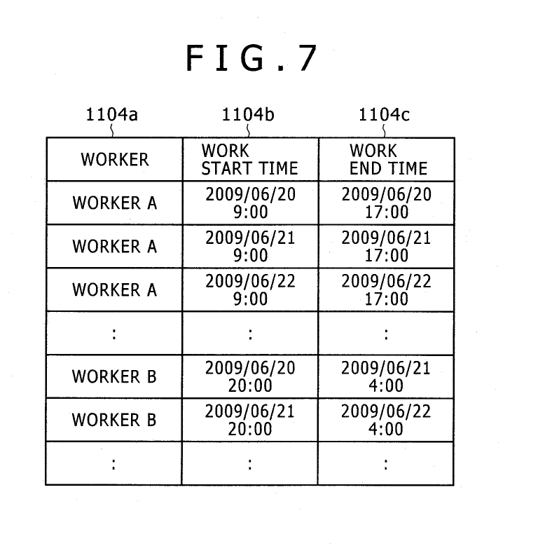

Returning to FIG. 1, the worker information storage area 1104 stores worker information that identifies a worker, the work start time of the worker, and the work end time of the worker. In the present embodiment, for example, the worker information storage area 1104 stores a worker information table shown in FIG. 7. As shown in FIG. 7, the worker information table has a worker column 1104a, a work start time column 1104b, and a work end time column 1104c. The worker column 1104a stores information that identifies a worker. The work start time column 1104b stores information that identifies the work start time of the worker identified by the worker column 1104a. The work end time column 1104c stores information that identifies the time at which the worker identified by the worker column 1104a ends his/her work after starting his/her work at the time identified by the work start time column 1104b.

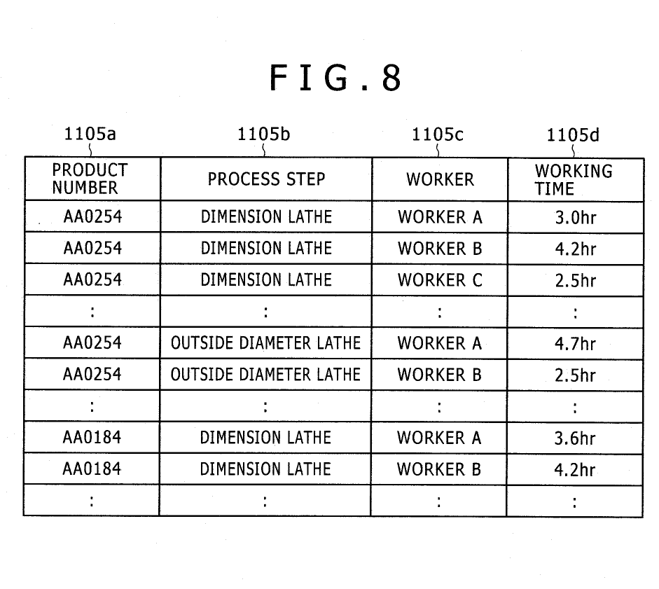

Returning to FIG. 1, the working time information storage area 1105 stores working time information that identifies a product, a process step for the product, a worker, and the working time that the worker requires to complete his/her job in the process step. In the present embodiment, for example, the working time information storage area 1105 stores a working time information table shown in FIG. 8. As shown in FIG. 8, the working time information table has a product number column 1105a, a process step column 1105b, a worker column 1105c, and a working time column 1105d. The product number column 1105a stores information that identifies a product. The process step column 1105b stores information that identifies a process step for the product identified by the product number column 1105a. The worker column 1105c stores information that identifies a worker. The working time column 1105d stores information that identifies working time that the worker identified by the worker column 1105c requires in the process step identified by the process step column 1105b and associated with the product identified by the product number column 1105a.

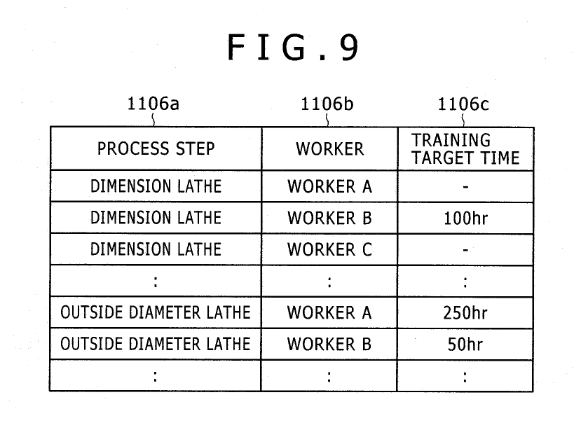

Returning to FIG. 1, the training target time information storage area 1106 stores training target time information that identifies a process step, a worker, and the training target time for the worker in the process step. In the present embodiment, for example, the training target time information storage area 1106 stores a training target time information table shown in FIG. 9. As shown in FIG. 9, the training target time information table has a process step column 1106a, a worker column 1106b, and a training target time column 1106c. The process step column 1106a stores information that identifies a process step. The worker column 1106b stores information that identifies a worker. The training target time column 1106c stores information that identifies the training target time for the worker identified by the worker column 1106b in the process step identified by the process step column 1106a.

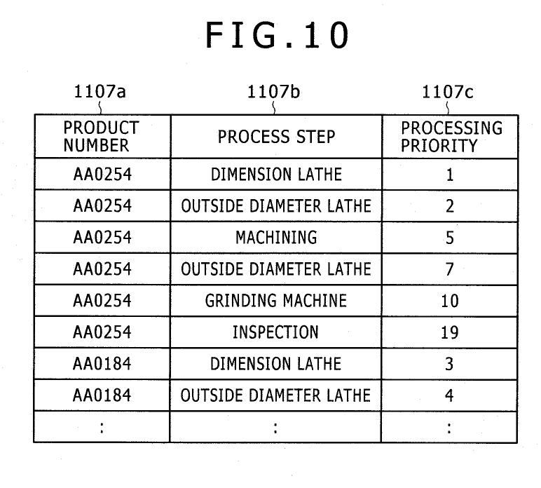

Returning to FIG. 1, the processing priority information storage area 1107 stores processing priority information that identifies a product, a process step for the product, and a processing priority of the process step. In the present embodiment, for example, the processing priority information storage area 1107 stores a processing priority information table shown in FIG. 10. As shown in FIG. 10, the processing priority information table has a product number column 1107a, a process step column 1107b, and a processing priority column 1107c. The product number column 1107a stores information that identifies a product. The process step column 1107b stores information that identifies a process step for the product identified by the product number column 1107a. The processing priority column 1107c stores information that identifies the processing priority of the process step identified by the process step column 1107b and associated with the product identified by the product number column 1107a. The processing priority is determined, for instance, by dividing the working time required for process steps remaining after each process step of each product by the time remaining before a delivery deadline and sorting various process steps for various products in an increasing order of the value resulting from the division. The processing priority may be dynamically changed by repeating the above calculation process at various points of time during a later-described worker assignment scheme creation process.

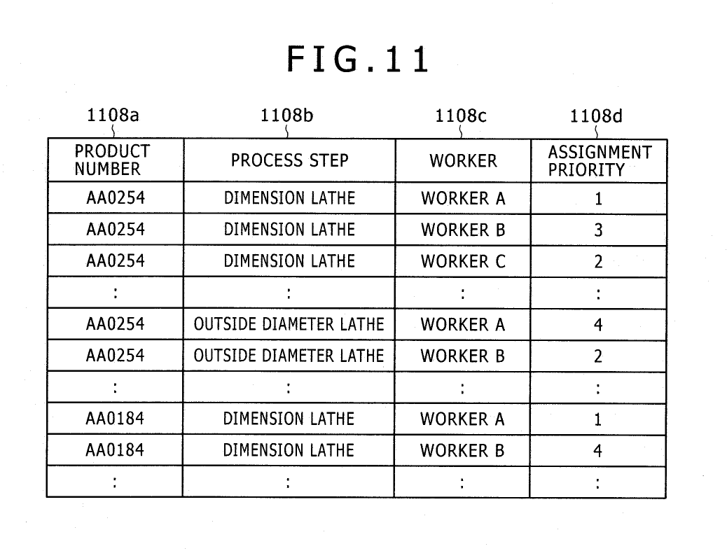

Returning to FIG. 1, the assignment priority information storage area 1108 stores assignment priority information that identifies a product, a process step for the product, a worker, and the assignment priority of the worker in the process step. In the present embodiment, for example, the assignment priority information storage area 1108 stores an assignment priority information table shown in FIG. 11. As shown in FIG. 11, the assignment priority information table has a product number column 1108a, a process step column 1108b, a worker column 1108c, and an assignment priority column 1108d. The product number column 1108a stores information that identifies a product. The process step column 1108b stores information that identifies a process step for the product identified by the product number column 1108a. The worker column 1108c stores information that identifies a worker. The assignment priority column 1108d stores information that identifies the assignment priority of the worker identified by the worker column 1108c in the process step identified by the process step column 1108b and associated with the product identified by the product number column 1108a. The assignment priority is to be changed in a later-described worker assignment priority change process. Initial assignment priority for each process step of each product, which prevails before the worker assignment priority change process, can be defined, for instance, by giving higher assignment priority to workers whose working time is relatively short.

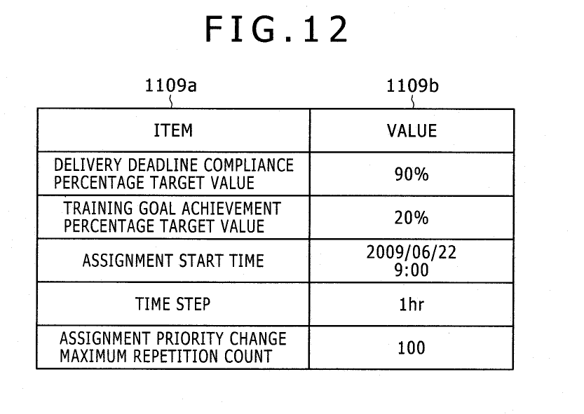

Returning to FIG. 1, the parameter information storage area 1109 stores parameter information that identifies a target value for a delivery deadline compliance percentage and parameter information that identifies a target value for a training goal achievement percentage. In the present embodiment, for example, the parameter information storage area 1109 stores a parameter information table shown in FIG. 12. As shown in FIG. 12, the parameter information table has an item column 1109a and a value column 1109b. The item column 1109a stores information that identifies a parameter. As the parameter identification information, the item column 1109a stores a delivery deadline compliance percentage target value, a training goal achievement percentage target value, an assignment start time, a time step, and an assignment priority change maximum repetition count. The value column 1109b stores information that identifies the value of the parameter identified by the item column 1109a.

The assignment start time is the time at which worker assignment scheme creation begins in the later-described worker assignment scheme creation process. The time step denotes the minimum time intervals at which a worker assigned to a job for a product is to be changed. The assignment priority change maximum repetition count is an upper-limit value for the number of times the assignment priority is to be changed in the worker assignment priority change process with a view toward achieving the delivery deadline compliance percentage target value and training goal achievement percentage target value.

Returning to FIG. 1, the work history information storage area 1110 stores information that identifies the worker assignment information created by the controller 120 and the job start time information and job completion time information about each process step of each product, which are calculated by the controller 120.

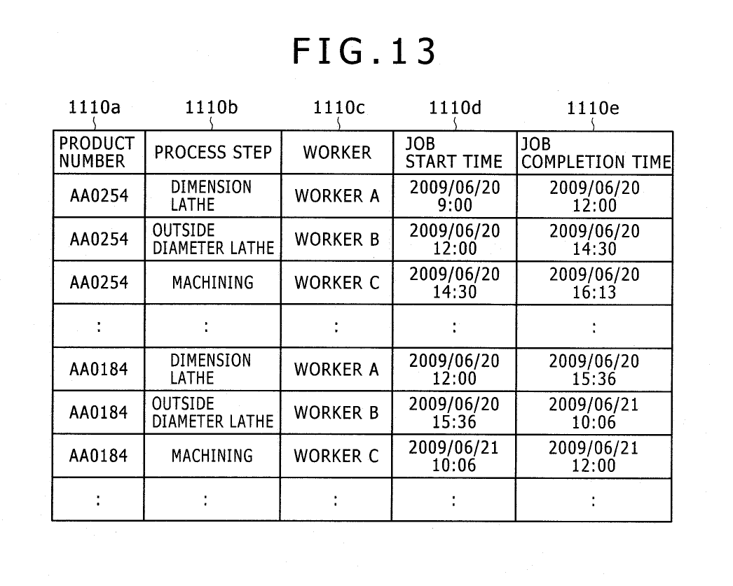

In the present embodiment, for example, the work history information storage area 1110 stores a work history information table shown in FIG. 13. As shown in FIG. 13, the work history information table has a product number column 1110a, a process step column 1110b, a worker column 1110c, a job start time column 1110d, and a job completion time column 1110e. The product number column 1110a stores information that identifies a product. The process step column 1110b stores information that identifies a process step for the product identified by the product number column 1110a. The worker column 1110c stores information that identifies a worker assigned by the controller 120 to the process step identified by the process step column 1110b and associated with the product identified by the product number column 1110a. The job start time column 1110d stores information that identifies the job start time calculated by the controller 120 for the process step identified by the process step column 1110b and associated with the product identified by the product number column 1110a. The job completion time column 1110e stores information that identifies the job completion time calculated by the controller 120 for the process step identified by the process step column 1110b and associated with the product identified by the product number column 1110a.

Returning to FIG. 1, the controller 120 includes an information acquisition section 121, a worker assignment scheme creation section 122, a work history information storage section 123, an evaluation value calculation section 124, and a worker assignment priority change section 125.

The information acquisition section 121 acquires necessary information from the order reception processing device 220, production planning device 230, and production line management device 240, and stores the acquired information in the storage. For example, the information acquisition section 121 acquires from the order reception processing device 220 the information to be stored as individual records in the product information table, and stores the acquired information in the product information table.

Further, the information acquisition section 121 acquires from the production planning device 230 the information to be stored as individual records in the process path information table, worker information table, working time information table, and training target time information table, and stores the acquired information in the process path information table, worker information table, working time information table, and training target time information table.

In addition, the information acquisition section 121 acquires from the production line management device 240 the information to be stored as individual records in a work result information table, and stores the acquired information in the work result information table. The information acquisition section 121 may acquire the information from the order reception processing device 220, production planning device 230, and production line management device 240 at a predetermined point of time, or store the information in the associated tables when the information is sent from these devices.

The worker assignment scheme creation section 122 creates a worker assignment scheme for each process step of each product, and calculates the job start time and job completion time for each process step of each product. For example, in accordance with the processing priority of a product being processed in a process step and the assignment priority of a worker in the process step of the product, the worker assignment scheme creation section 122 creates a worker assignment scheme for each process step of each product and calculates the job start time and job completion time.

The work history information storage section 123 stores the results of processing performed by the worker assignment scheme creation section 122 in the work history information storage area 1110.

For example, the work history information storage section 123 stores the worker assignment scheme for each process step of each product, which is created by the worker assignment scheme creation section 122, and the job start time and job completion time for each process step of each product, which is calculated by the worker assignment scheme creation section 122, in the work history information table.

The evaluation value calculation section 124 calculates evaluation values concerning delivery deadline compliance and efficient worker training in accordance with the information stored in the work history information storage area 1110. For example, the evaluation value calculation section 124 acquires the job completion time for a final process step of each product from the work history information table and calculates the delivery deadline compliance percentage of a product from the delivery deadline information about the product. Further, the evaluation value calculation section 124 calculates the work engagement time of each worker in each process step from the work history information table and the training goal achievement percentage of each worker in each process step and the training goal achievement percentage of all workers from the training target time information.

The worker assignment priority change section 125 changes the worker assignment priority in accordance with the results of processing performed by the evaluation value calculation section 124, the delivery deadline compliance percentage target value, and the training goal achievement percentage target value. When, for instance, the delivery deadline compliance percentage in the evaluation value calculation section 124 is smaller than the delivery deadline compliance percentage target value, the worker assignment priority change section 125 gives higher assignment priority to workers whose working time is relatively short than to workers assigned to each process step of each product in the work history information storage area 1110. Further, when, for instance, the training goal achievement percentage in the evaluation value calculation section 124 is smaller than the training goal achievement percentage target value, the worker assignment priority change section 125 gives higher assignment priority to workers whose working time is relatively long than to workers assigned to each process step of each product in the work history information storage area 1110.

The input section 130 receives information input from the user of the worker assignment device 210 when the user enters the information to be stored in the parameter information storage area 1109.

The display 140 outputs the results of processing performed by the controller 120. The display 140 may, for example, simultaneously output the delivery deadline compliance percentage and training goal achievement percentage of each of plural worker assignment schemes.

The communication section 150 exchanges information through the network 250.

The order reception processing device 220 receives product information input from a user of the worker assignment system, and transmits the received product information to the worker assignment device 210 at a predetermined point of time or in response to a request from the worker assignment device 210.

The production planning device 230 receives process path information, worker information, working time information, and training target time information input from the user of the worker assignment system, and transmits the received process path information, worker information, working time information, and training target time information to the worker assignment device 210 at a predetermined point of time or in response to a request from the worker assignment device 210.

The production line management device 240 receives work result information input from each production device installed in a production line or from a user of each production device, and transmits the received work result information to the worker assignment device 210 at a predetermined point of time or in response to a request from the worker assignment device 210.

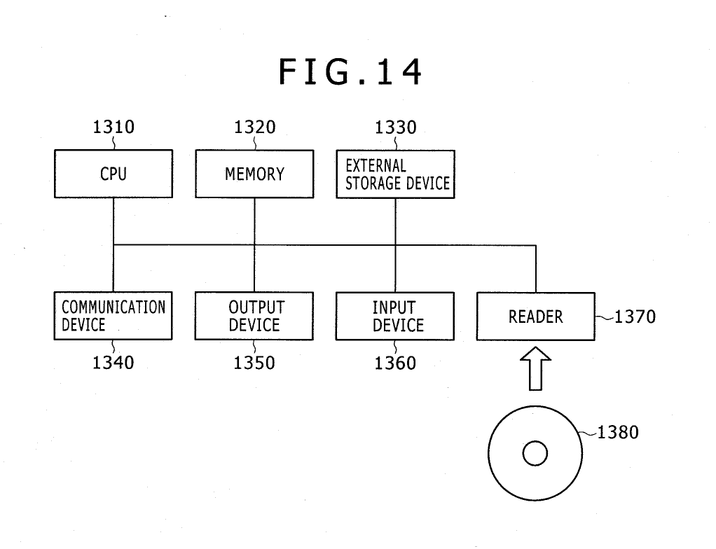

The worker assignment device 210 described above can be implemented, for instance, by a common computer that includes, as shown in FIG. 14, a CPU (Central Processing Unit) 1310, a memory 1320, an external storage device 1330 such as a HDD (hard disk drive), a reader 1370 that reads information from and writes information to a portable storage medium 1380 such as a CD (Compact Disk) or DVD (Digital Versatile Disk), an input device 1360 such as a keyboard or a mouse, an output device 1350 such as a display, and a communication device 1340 such as an NIC (Network Interface Card) for connecting to a communication network.

The storage 110 can be implemented when, for instance, the CPU 1310 uses the memory 1320 or the external storage device 1330. The controller 120 can be implemented when, for instance, a predetermined program stored in the external storage device 1330 is loaded into the memory 1320 and executed by the CPU 1310. The input section 130 can be implemented when, for instance, the CPU 1310 uses the input device 1360. The display 140 can be implemented when, for instance, the CPU 1310 uses the output device 1350. The communication section 150 can be implemented when, for instance, the CPU 1310 uses the communication device 1340.

The above-mentioned predetermined program may be downloaded into the external storage device 1330 from the storage medium 1380 through the reader 1370 or from a network through the communication device 1340, then loaded into the memory 1320, and executed by the CPU 1310. Alternatively, the predetermined program may be directly downloaded into the memory 1320 from the storage medium 1380 through the reader 1370 or from a network through the communication device 1340, and then executed by the CPU 1310.

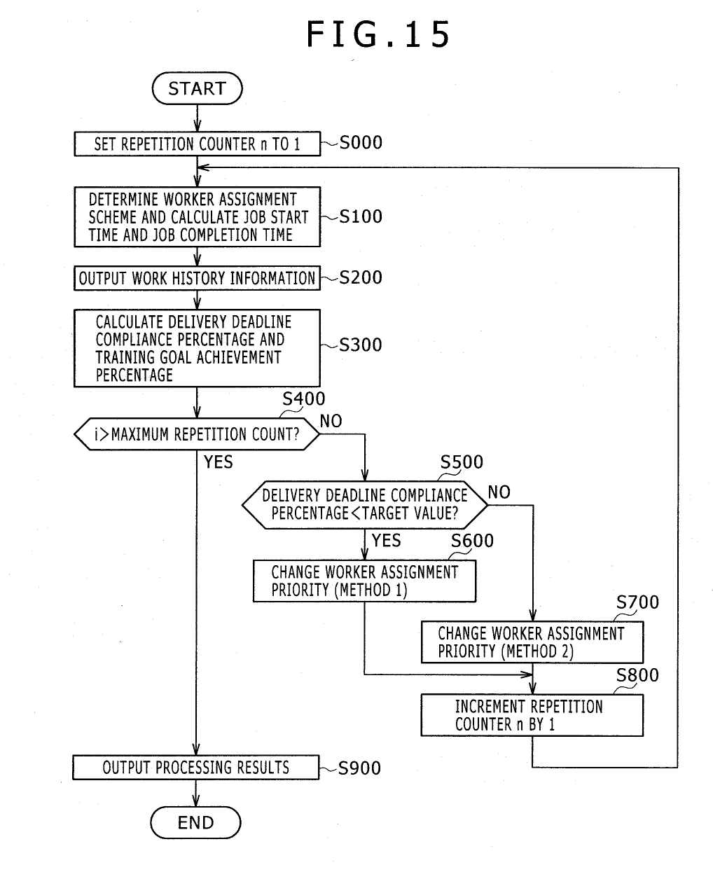

The worker assignment system described above performs a later-described worker assignment scheme creation process, evaluation value calculation process, and worker assignment priority change process to create a worker assignment scheme that simultaneously complies with a product delivery deadline and provides efficient worker training. An embodiment of the present invention will be described below in detail with reference to a flowchart shown in FIG. 15.

First of all, step S000 is performed to set a repetition counter n for the worker assignment priority change process to an initial value of 1.

Next, step S100 is performed in accordance with the processing priority of each process step of each product and the assignment priority of workers in each process step of each product to create a worker assignment scheme for each process step of each product and calculate the job start time and job completion time for each process step of each product.

Next, step S200 is performed so that the work history information table 1110 stores the worker assignment scheme created in step S100 and the job start time and job completion time calculated in step S100.

Next, step S300 is performed to calculate the delivery deadline compliance percentage and training goal achievement percentage in accordance with the worker assignment scheme information and job start time and job completion time information in the work history information table 1110.

The delivery deadline compliance percentage is the ratio of the number of delivery-deadline-compliant products to the total number of products and calculated from Equation 1.

$$Delivery deadline compliance percentage Y = \frac{{\sum }_{i = 1}^{N} {H}_{i}}{Total number of products N} \\ {H}_{i} = \{ \begin{matrix}0 ( Delivery deadline {d}_{i} < Job completion day {t}_{i}^{f} ) \\ 1 ( Delivery deadline {d}_{i} \geq Job completion day {t}_{i}^{f} )\end{matrix} \qquad ( Equation 1 )$$

where the delivery deadline dᵢ and the job completion day t^{f}ᵢ are the delivery deadline and final process completion day of a product i, respectively.

The training goal achievement percentage is the average ratio of the work engagement time to the training target time for each worker in each process step and calculated from Equation 2.

$$Training goal achievement percentage E = \frac{{\sum }_{i = 1}^{M} {\sum }_{j = 1}^{P} {e}_{i , j}}{\begin{matrix}Total number of workers M \times \\ total number of process steps P\end{matrix}} \\ {e}_{i , j} = \frac{\begin{matrix}Engagement time of \\ worker i in processing step j\end{matrix}}{\begin{matrix}Training target time for \\ worker i in process step j\end{matrix}} \qquad ( Equation 2 )$$

Next, step S400 is performed to judge whether the value of the repetition counter n is greater than the maximum repetition count. If the value of the repetition counter n is greater than the maximum repetition count, the flow proceeds to step S900. If, on the other hand, the value of the repetition counter n is not greater than the maximum repetition count, the flow proceeds to step S500.

Step S500 is performed to judge whether the delivery deadline compliance percentage calculated in step S300 is smaller than the delivery deadline compliance percentage target value. If the calculated delivery deadline compliance percentage is smaller than the delivery deadline compliance percentage target value, the flow proceeds to step S600. If, on the other hand, the calculated delivery deadline compliance percentage is not smaller than the delivery deadline compliance percentage target value, the flow proceeds to step S700.

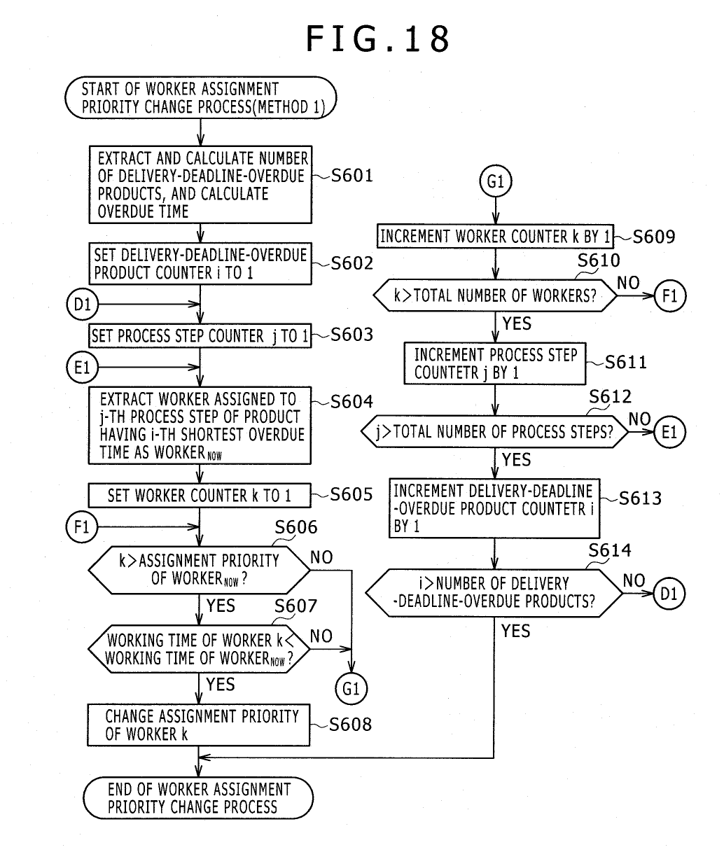

In step S600, the worker assignment priority is changed with a view toward increasing the delivery deadline compliance percentage. A method of changing the worker assignment priority with a view toward increasing the delivery deadline compliance percentage is referred to as method 1. Method 1 will be described in detail later with reference to FIG. 18.

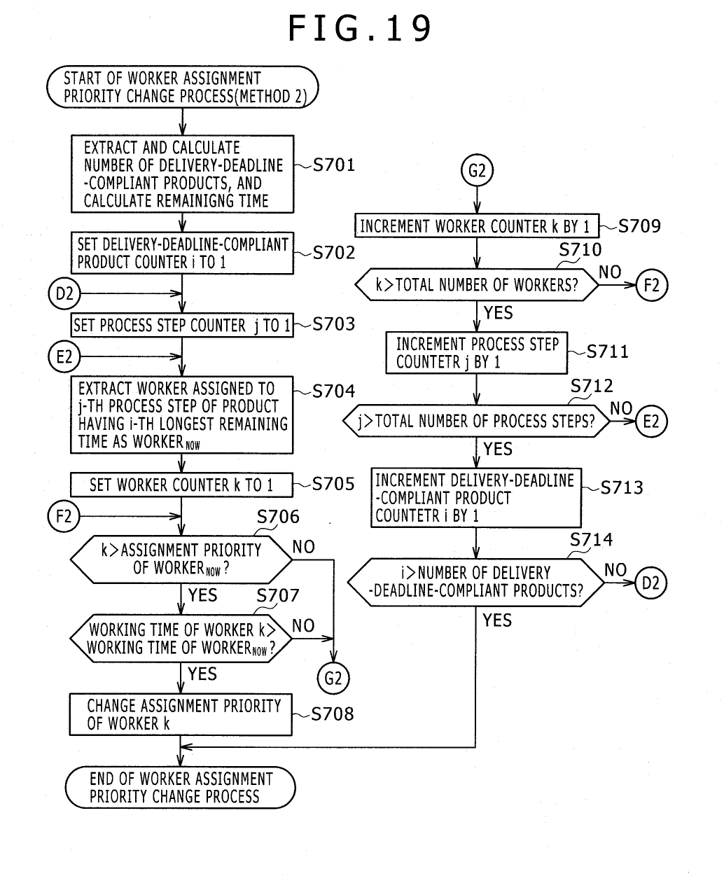

In step S700, the worker assignment priority is changed with a view toward increasing the training goal achievement percentage. A method of changing the worker assignment priority with a view toward increasing the training goal achievement percentage is referred to as method 2. Method 2 will be described in detail later with reference to FIG. 19.

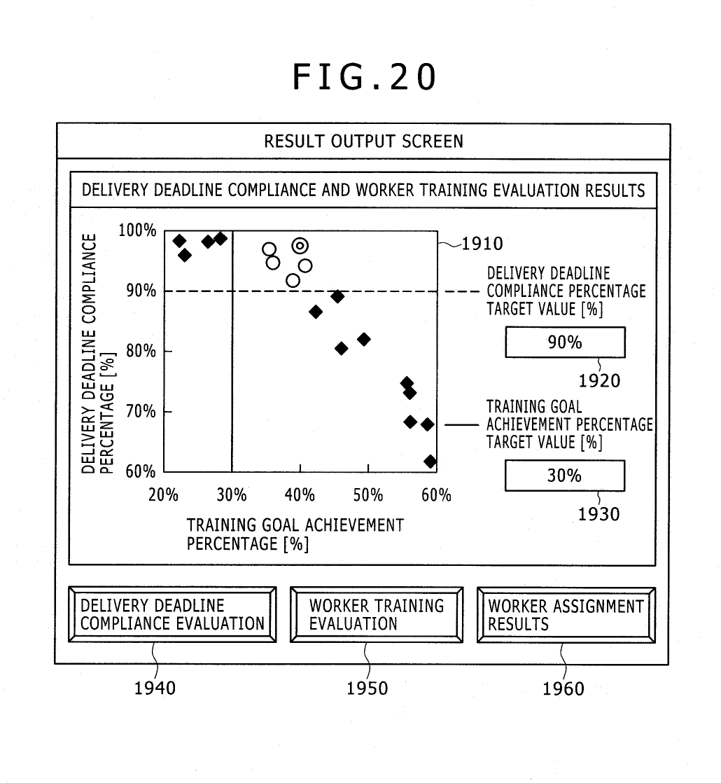

In step S800, the repetition counter n is incremented by 1. In step S900, the results of processing are output. A method of processing result output will be described later with reference to display screen examples shown in FIGS. 20 to 24.

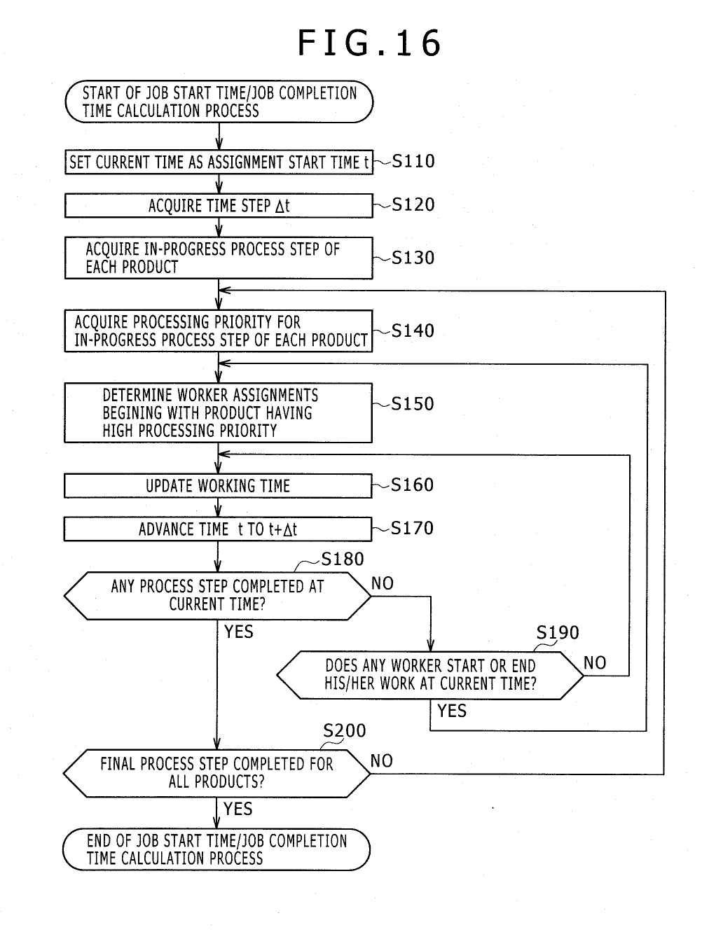

FIG. 16 is a flowchart illustrating a process that is performed in step S100, which is shown in FIG. 15, in accordance with the processing priority of a process step of each product and the assignment priority of a worker in each process step to create a worker assignment scheme for each process step of each product and calculate the job start time and job completion time for each process step of each product.

In step S110, the current time is set as the assignment start time.

In step S120, the time step is acquired from the parameter information table to regard the acquired value as £t.

In step S130, the in-progress process step of each product is acquired from the in-progress process step information table.

In step S140, a product and process step acquired in step S130 are referenced in the processing priority information table to acquire the processing priority of the product in the process step.

In step S150, worker assignments are determined sequentially beginning with a product having high processing priority in accordance with the processing priority acquired in step S140.

In step S160, the remaining working time for each process step of each product is calculated on the assumption that the time advances by the time step in relation to the worker assignment scheme for the current time. As the working time varies from one worker to another, it is necessary to calculate the remaining working time of each worker. Equation 3, for example, calculates the remaining working time of each worker in accordance with the remaining working time ratio between a worker assigned at the current time and each of the other workers.

$$Working time ST ( i , j , k , t + Δ t ) = ST ( i , j , k , t ) - \frac{ST ( i , j , k , t )}{ST ( i , j , m ( i , j , t ) , t )} Δ t \qquad ( Equation 3 )$$

where i is a product counter value, j is a process step counter value, k is a worker counter value, ST(i,j,k,t) is the remaining working time required for worker k in process step j of product i at time t, m(i,j,t) is a worker counter value of a worker assigned to process step j of product i at time t, and Δt is the time step.

In step S170, the time is advanced by adding the time step to the current time.

Step S180 is performed to check for a process step that has a working time value of not greater than 0 (zero) upon completion of step S170. If there is a process step having a working time value of not greater than 0 (zero), the flow proceeds to step S200. If, on the other hand, there is no such process step, the flow proceeds to step S190.

Step S190 is performed to check for a worker who starts or ends his/her work during a time interval between the instant at which step S170 starts and the instant at which step S170 ends. If any worker starts or ends his/her work during such a time interval, the flow proceeds to step S150. If, on the other hand, no worker starts or ends his/her work during such a time interval, the flow proceeds to step S160.

Step S200 is performed to judge whether a final process step is completed for all products. If the final process step is completed for all products, the flow terminates. If, on the other hand, the final process step is not completed for all products, the flow proceeds to step S140.

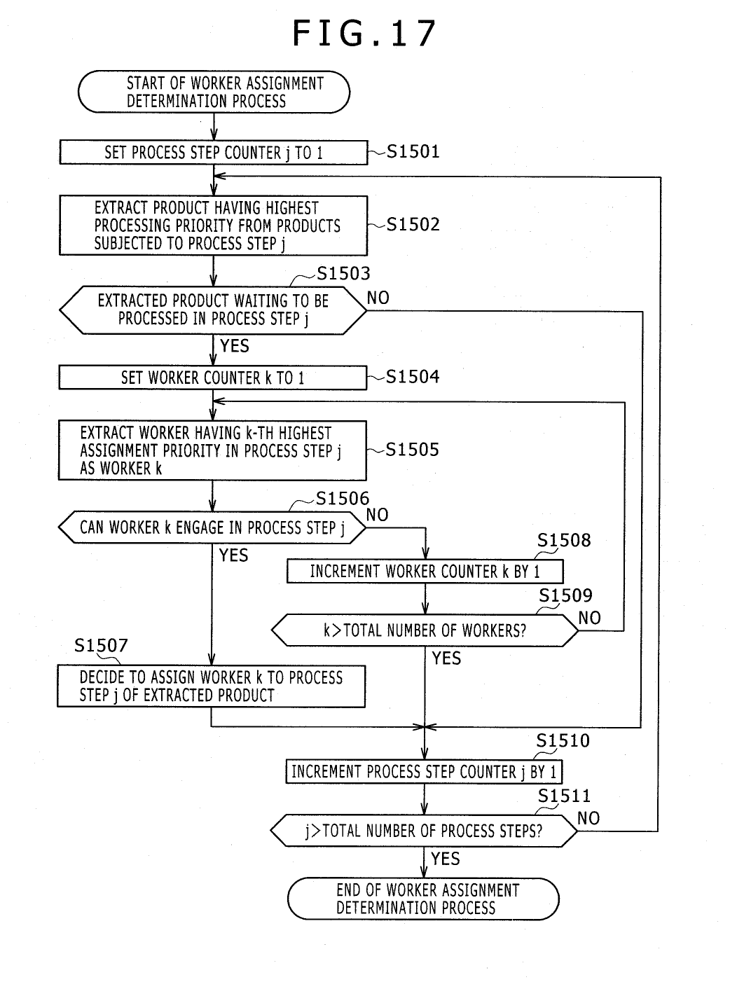

FIG. 17 is a flowchart illustrating a process that is performed in step S150, which is shown in FIG. 16, in accordance with the processing priority of a process step of each product and the assignment priority of a worker in each process step to create a worker assignment scheme for each process step of each product.

In step S1501, a process step counter j is set to an initial value of 1.

In step S1502, a product having the highest processing priority is extracted from products subjected to process step j. Here, the processing priority is set by dividing the working time required for process steps remaining after each process step of each product by the time remaining before a delivery deadline and sorting various products in an increasing order of the value resulting from the division. The processing priority may be dynamically changed at each point of time.

Step S1503 is performed to judge whether the product extracted in step S1502 is waiting to be processed in process step j. If the extracted product is waiting to be processed in process step j, the flow proceeds to step S1504. If, on the other hand, the extracted product is not waiting to be processed in process step j, the flow proceeds to step S1510.

In step S1504, a worker counter k is set to an initial value of 1.

In step S1505, a worker having the k-th highest assignment priority in process step j is extracted and regarded as worker k. The assignment priority is to be changed in the later-described worker assignment priority change process. The initial assignment priority for each process step of each product, which prevails before the worker assignment priority change process, can be defined, for instance, by giving higher assignment priority to workers whose working time is relatively short.

Step S1506 is performed to judge whether worker k can engage in process step j. If worker k can engage in process step j, the flow proceeds to step S1507. If, on the other hand, worker k cannot engage in process step j, the flow proceeds to step S1508. Whether or not worker k can engage in process step j can be determined, for instance, by checking whether the current time is not outside worker k's working hours and whether worker k is not assigned to a process step other than process step j at the current time. If the current time is not outside worker k's working hours and worker k is not assigned to a process step other than process step j at the current time, it can be concluded that worker k can engage in process step j. If, on the other hand, the current time is outside worker k's working hours or worker k is assigned to a process step other than process step j at the current time, it can be concluded that worker k cannot engage in process step j.

Step S1507 is performed to determine that worker k is to be assigned to process step j at the current time.

In step S1508, the worker counter k is incremented by 1.

Step S1509 is performed to judge whether the value of the worker counter k is greater than the total number of workers. If the value of the worker counter k is greater than the total number of workers, the flow proceeds to step S1510. If, on the other hand, the value of the worker counter k is not greater than the total number of workers, the flow proceeds to step S1505.

In step S1510, the process step counter j is incremented by 1.

Step S1511 is performed to judge whether the value of the process step counter j is greater than the total number of process steps. If the value of the process step counter j is greater than the total number of process steps, the flow terminates. If, on the other hand, the value of the process step counter j is not greater than the total number of process steps, the flow proceeds to step S1502.

FIG. 18 is a flowchart illustrating a process that is performed in step S600, which is shown in FIG. 15, to change the assignment priority of a worker. The flowchart shown in FIG. 18 depicts an assignment priority change process that is performed to increase the delivery deadline compliance percentage when it is smaller than the delivery deadline compliance percentage target value.

Step S601 is performed to extract products whose job completion time in a final process step is past a delivery deadline as delivery-deadline-overdue products, calculate the number of delivery-deadline-overdue products, and calculate the overdue time relative to the delivery deadline by subtracting a deadline time from the job completion time in the final process step of each delivery-deadline-overdue product.

In step S602, a delivery-deadline-overdue product counter i is set to an initial value of 1.

In step S603, the process step counter j is set to an initial value of 1.

Step S604 is performed to extract a product having the i-th smallest overdue time from the delivery-deadline-overdue products as product i, extract the j-th process step of product i as process step j, and extract a worker assigned to process step j of product as worker_{NOW}.

In step S605, the worker counter k is set to an initial value of 1.

Step S606 is performed to judge whether the value of the worker counter k is greater than the assignment priority of worker_{NOW} in process step j of product i. If the value of the worker counter k is greater than the assignment priority of worker_{NOW} in process step j of product i, the flow proceeds to step S607. If, on the other hand, the value of the worker counter k is not greater than the assignment priority of worker_{NOW} in process step j of product i, the flow proceeds to G1.

Step S607 is performed to extract a worker having the k-th lowest assignment priority in process step j of product i as worker k and judge whether the working time of worker k in process step j of product i is shorter than the working time of worker_{NOW}. If the working time of worker k in process step j of product i is shorter than the working time of worker_{NOW}, the flow proceeds to step S608. If, on the other hand, the working time of worker k in process step j of product i is not shorter than the working time of worker_{NOW}, the flow proceeds to G1.

Step S608 is performed to change the assignment priority of worker k in process step j of product i. For example, the assignment priority of worker k is replaced by the assignment priority of worker_{NOW}.

In step S609, the worker counter k is incremented by 1.

Step S610 is performed to judge whether the value of the worker counter k is greater than the total number of workers. If the value of the worker counter k is greater than the total number of workers, the flow proceeds to step S611. If, on the other hand, the value of the worker counter k is not greater than the total number of workers, the flow proceeds to F1.

In step S611, the process step counter j is incremented by 1.

Step S612 is performed to judge whether the value of the process step counter j is greater than the total number of process steps. If the value of the process step counter j is greater than the total number of process steps, the flow proceeds to step S613. If, on the other hand, the value of the process step counter j is not greater than the total number of process steps, the flow proceeds to E1.

In step S613, the delivery-deadline-overdue product counter is incremented by 1.

Step S614 is performed to judge whether the value of the delivery-deadline-overdue product counter i is greater than the number of delivery-deadline-overdue products. If the value of the delivery-deadline-overdue product counter i is greater than the number of delivery-deadline-overdue products, the flow terminates. If, on the other hand, the value of the delivery-deadline-overdue product counter i is not greater than the number of delivery-deadline-overdue products, the flow proceeds to D1.

FIG. 19 is a flowchart illustrating a process that is performed in step S700, which is shown in FIG. 15, to change the assignment priority of a worker. The flowchart shown in FIG. 19 depicts an assignment priority change process that is performed to increase the training goal achievement percentage when the delivery deadline compliance percentage is greater than the delivery deadline compliance percentage target value.

Step S701 is performed to extract products whose job completion time in a final process step is before a delivery deadline as delivery-deadline-compliant products, calculate the number of delivery-deadline-compliant products, and calculate the time remaining before the delivery deadline by subtracting the job completion time in the final process step of each delivery-deadline-compliant product from the deadline.

In step S702, a delivery-deadline-compliant product counter is set to an initial value of 1.

In step S703, the process step counter j is set to an initial value of 2.

Step S704 is performed to extract a product having the i-th longest remaining time from the delivery-deadline-compliant products as product i, extract the j-th process step of product as process step j, and extract a worker assigned to process step j of product i as worker_{NOW}.

In step S705, the worker counter k is set to an initial value of 1.

Step S706 is performed to judge whether the value of the worker counter k is greater than the assignment priority of worker_{Now} in process step j of product i. If the value of the worker counter k is greater than the assignment priority of worker_{NOW} in process step j of product i, the flow proceeds to step S707. If, on the other hand, the value of the worker counter k is not greater than the assignment priority of worker_{NOW} in process step j of product i, the flow proceeds to G2.

Step S707 is performed to extract a worker having the k-th lowest assignment priority in process step j of product i as worker k and judge whether the working time of worker k is longer than the working time of worker_{NOW}. If the working time of worker k is longer than the working time of worker_{NOW}, the flow proceeds to step S708. If, on the other hand, the working time of worker k is not longer than the working time of worker_{Now}, the flow proceeds to G2.

Step S708 is performed to change the assignment priority of worker k in process step j of product i. For example, the assignment priority of worker k is replaced by the assignment priority of worker_{NOW}.

In step S709, the worker counter k is incremented by 1.

Step S710 is performed to judge whether the value of the worker counter k is greater than the total number of workers. If the value of the worker counter k is greater than the total number of workers, the flow proceeds to step S711. If, on the other hand, the value of the worker counter k is not greater than the total number of workers, the flow proceeds to F2.

In step S711, the process step counter j is incremented by 1.

Step S712 is performed to judge whether the value of the process step counter j is greater than the total number of process steps. If the value of the process step counter j is greater than the total number of process steps, the flow proceeds to step S713. If, on the other hand, the value of the process step counter j is not greater than the total number of process steps, the flow proceeds to E2.

In step S713, the delivery-deadline-compliant product counter i is incremented by 1.

Step S714 is performed to judge whether the value of the delivery-deadline-compliant product counter i is greater than the number of delivery-deadline-compliant products. If the value of the delivery-deadline-compliant product counter i is greater than the number of delivery-deadline-compliant products, the flow terminates. If, on the other hand, the value of the delivery-deadline-compliant product counter i is not greater than the number of delivery-deadline-compliant products, the flow proceeds to D2.

FIG. 20 is a schematic diagram illustrating an exemplary display screen. As shown in FIG. 20, the display screen has an evaluation result display area 1910, a delivery deadline compliance percentage target value input area 1920, a worker training goal achievement percentage target value input area 1930, a delivery deadline compliance evaluation output button area 1940, a worker training evaluation output button area 1950, and a worker assignment result output button area 1960.

The evaluation result display area 1910 displays a diagram whose axes respectively represent the training goal achievement percentage and the delivery deadline compliance percentage. The results of training goal achievement percentage and delivery deadline compliance percentage calculations performed by the controller in relation to individual worker assignments are plotted in the diagram. Further, as shown in FIG. 20, the delivery deadline compliance percentage target value and training goal achievement percentage target value may be indicated by lines in the diagram. Furthermore, points at which the delivery deadline compliance percentage is greater than its target value and the training goal achievement percentage is greater than its target value may be highlighted. In FIG. 20, for example, results achieving the delivery deadline compliance percentage target value and training goal achievement percentage target value are indicated by a clear circle, a result achieving the highest delivery deadline compliance percentage is indicated by a clear double circle, and the other results are indicated by a colored rhombus.

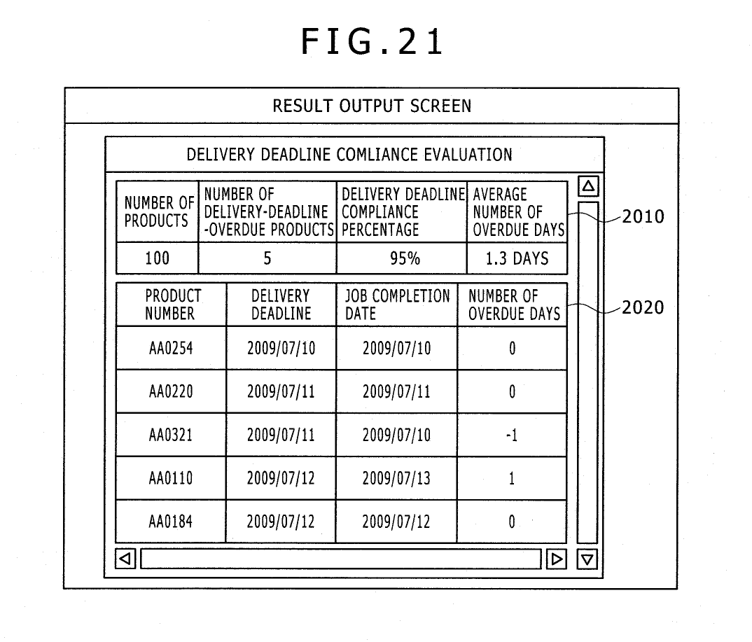

When the user of the worker assignment device selects an arbitrary point plotted in the diagram and then selects the delivery deadline compliance evaluation output button area 1940, the worker assignment device outputs delivery deadline compliance evaluation results that are shown in FIG. 21 and will be described later.

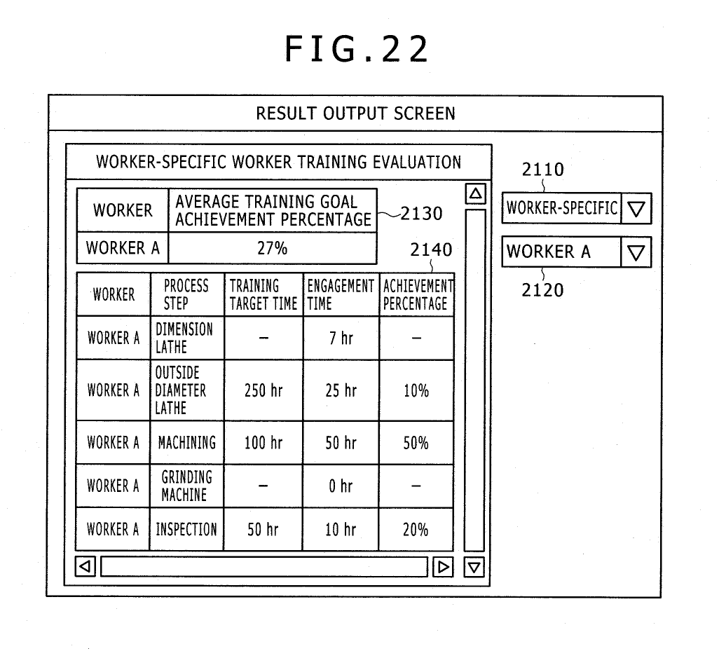

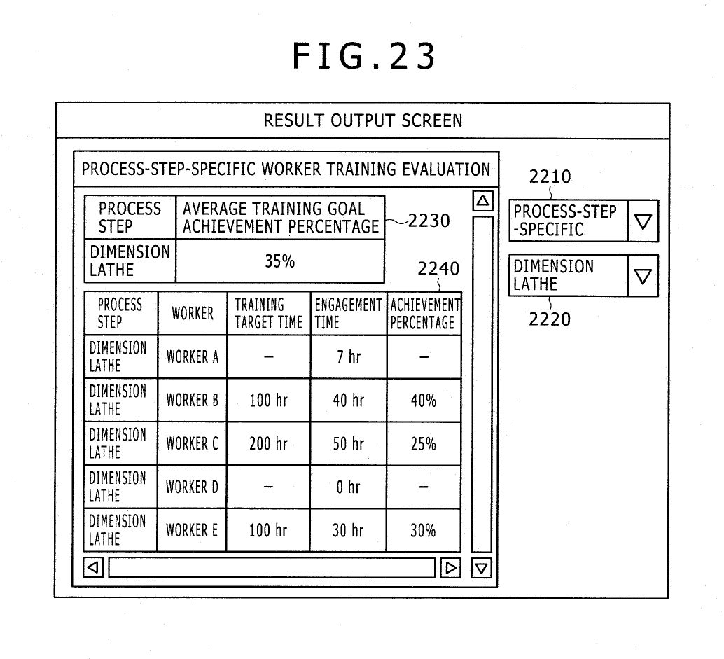

Further, when the user of the worker assignment device selects an arbitrary point plotted in the diagram and then selects the worker training evaluation output button area 1950, the worker assignment device outputs worker training evaluation results that are shown in FIGS. 22 and 23 and will be described later.

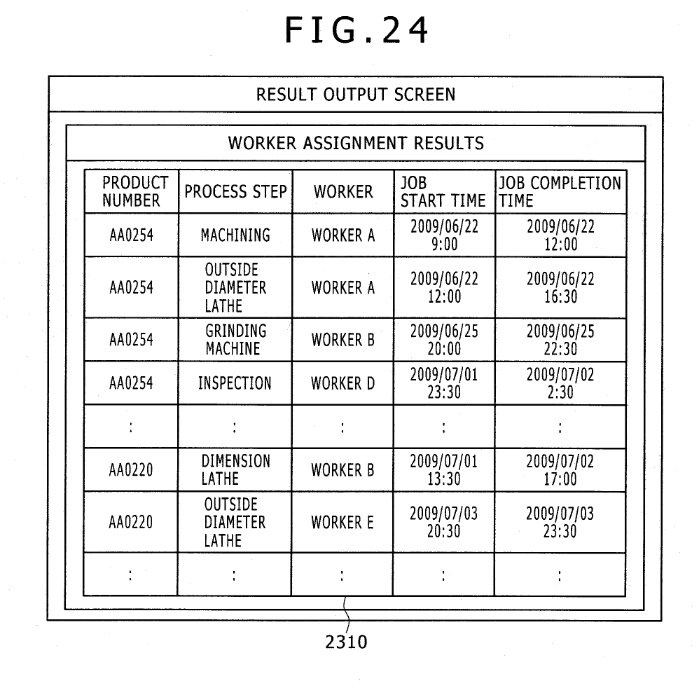

Furthermore, when the user of the worker assignment device selects an arbitrary point plotted in the diagram and then selects the worker assignment result output button area 1960, the worker assignment device outputs worker assignment results that are shown in FIG. 24 and will be described later.

FIG. 21 is a schematic diagram illustrating an exemplary display screen. As regards a worker assignment scheme corresponding to a point selected from the diagram shown in FIG. 20, the display screen outputs later-described evaluation results of delivery deadline compliance. As shown in FIG. 21, the display screen has an overall evaluation display area 2010 and an individual product evaluation display area 2020. The overall evaluation display area 2010 outputs the total number of products, the number of delivery-deadline-overdue products, the delivery deadline compliance percentage, and the average number of overdue days. The individual product evaluation display area 2020 outputs a product number, a delivery deadline, a job completion date, and the number of overdue days.

FIGS. 22 and 23 are schematic diagrams illustrating an exemplary display screen. As regards a worker assignment scheme corresponding to a point selected from the diagram shown in FIG. 20, the display screen outputs later-described evaluation results of worker training.

FIG. 22 shows data that appears when “Worker-Specific” is chosen from a later-described display selection area 2110. Selecting “Worker-Specific” causes the display to output worker-specific worker training evaluation results. As shown in FIG. 22, the display screen has the display selection area 2110, a worker selection area 2120, an overall evaluation display area 2130, and an individual process step evaluation display area 2140. When “Worker-Specific” is chosen from the display selection area 2110 with “Worker A” chosen from the worker selection area 2120, the display causes the overall evaluation display area 2130 to output average training goal achievement percentage information about all process steps of worker A and the individual process step evaluation display area 2140 to output training goal achievement percentage information about each process step of worker A.

FIG. 23 shows data that appears when “Process-Step-Specific” is chosen from a display selection area 2210. Selecting “Process-Step-Specific” causes the display to output process-step-specific worker training evaluation results. As shown in FIG. 23, the display screen has the display selection area 2210, a process step selection area 2220, an overall evaluation display area 2230, and an individual worker evaluation display area 2240. When “Process-Step-Specific” is chosen from the display selection area 2210 with “Dimension Lathe” chosen from the process step selection area 2220, the display causes the overall evaluation display area 2230 to output average training goal achievement percentage information about the dimension lathe process steps of all workers and the individual worker evaluation display area 2240 to output training goal achievement percentage information about the dimension lathe process step of each worker.

FIG. 24 is a schematic diagram illustrating an exemplary display screen. This display screen outputs later-described worker assignment results corresponding to a point selected from the diagram shown in FIG. 20. As shown in FIG. 24, the display screen has a worker assignment display area 2310. The worker assignment display area 2310 outputs a product number, a process step, an assigned worker, a job start time, and a job completion time.

When the above display method is employed, the user of the worker assignment device can compare plural sets of results from the viewpoints of delivery deadline compliance percentage and training goal achievement percentage, select a set of results most favorable to the user, output a worker assignment scheme included in the selected set of results, and use the output results to issue worker assignment instructions.

As described above, the present embodiment makes it possible to create a worker assignment scheme for a manufacturing process that increases both the product delivery deadline compliance percentage and the worker training goal achievement percentage.

It should be understood by those skilled in the art that various modifications, combinations, sub-combinations, and alterations may occur depending on design requirements and other factors insofar as they are within the scope of the appended claims or the equivalents thereof.

What is claimed is:

1. A worker assignment device that assigns workers to various jobs involved in a manufacturing process, the device comprising:
a storage;
a controller;
an input section;
a display; and
a communication section;
wherein the controller includes
an information acquisition section that acquires product information identifying a product-specific delivery deadline and process path, process step information, product-specific in-progress process step information, work information about workers, working time information about workers, training target time information about workers, processing priority information concerning products and process steps, and assignment priority information concerning products, process steps and workers from an external system through the communication section and stores the acquired information in the storage,
a worker assignment scheme creation section that performs a process for creating a worker assignment scheme for each process step of each product and a process for calculating a job start time and job completion time for each process step of each product in accordance with the processing priority information and the assignment priority information,
a work history information storage section that stores work history information created by the worker assignment scheme creation section in the storage, the work history information including worker assignment information and job start time information and job completion time information about each process step of each product,
an evaluation value calculation section that performs a process for calculating a delivery deadline compliance evaluation value indicative of the percentage of delivery deadline compliance in accordance with the worker assignment information, the job start time information, the job completion time information, and product-specific delivery deadline information, and a process for calculating a worker training evaluation value indicative of the percentage of training goal achievement in the worker assignment scheme in accordance with the result of worker assignment scheme creation and training goal information about each worker, and
a worker assignment priority change section that performs, in accordance with processing results produced by the evaluation value calculation section, a delivery deadline compliance percentage target value, a worker training goal achievement percentage target value, and the working time information about each process step of each worker, a process for applying a worker assignment priority change so as to preferentially assign workers whose working time is relatively short to a process step of a delivery-deadline-overdue product if the delivery deadline compliance evaluation value has not reached a target value, and preferentially assign workers whose working time is relatively long to a process step of a delivery-deadline-compliant product if the worker training evaluation value has not reached a target value, and causes the display to perform a process for displaying plural worker assignment schemes for comparison purposes by simultaneously displaying the delivery deadline compliance evaluation value and the worker training evaluation value, which are the processing results produced by the controller.

2. A computer readable medium storing a worker assignment program causing a computer to function as a worker assignment device and execute a process for assigning workers to various jobs involved in a manufacturing process, wherein the computer includes a control unit and a display unit, the process comprising:
causing the control unit to perform a process for creating a worker assignment scheme for each process step of each product in accordance with worker assignment rule information, a process for calculating a job completion time for each product, a process for calculating a delivery deadline compliance evaluation value indicative of the percentage of delivery deadline compliance in accordance with the calculated job completion time and delivery deadline information about each product, a process for calculating a worker training evaluation value indicative of the percentage of training goal achievement in the worker assignment scheme in accordance with the result of worker assignment scheme creation and training goal information about each worker, and a process for applying a worker assignment rule change, in accordance with processing results produced by the evaluation value calculation section, a delivery deadline compliance percentage target value, a worker training goal achievement percentage target value, and the working time information about each process step of each worker, so as to preferentially assign workers whose working time is relatively short to a process step of a delivery-deadline-overdue product if the delivery deadline compliance evaluation value has not reached a target value, and preferentially assign workers whose working time is relatively long to a process step of a delivery-deadline-compliant product if the worker training evaluation value has not reached a target value; and
causing the display unit to perform a process for displaying plural worker assignment schemes for comparison purposes by simultaneously displaying the delivery deadline compliance evaluation value and the worker training evaluation value, which are the processing results produced by the control unit.

3. A worker assignment system that assigns workers to various jobs involved in a manufacturing process, the system comprising:
a controller; and
a display;
wherein the controller includes
a worker assignment scheme creation section that performs a process for creating a worker assignment scheme for each process step of each product and a process for calculating a job completion time for each product in accordance with the worker assignment rule information,
an evaluation value calculation section that performs a process for calculating a delivery deadline compliance evaluation value indicative of the percentage of delivery deadline compliance in accordance with the result of job completion time calculation and the delivery deadline information about each product, and performs a process for calculating a worker training evaluation value indicative of the percentage of training goal achievement in the worker assignment scheme in accordance with the result of worker assignment scheme creation and training goal information about each worker, and
a worker assignment priority change section that performs, in accordance with processing results produced by the evaluation value calculation section, a delivery deadline compliance evaluation target value, a worker training evaluation target value, and the working time information about each process step of each worker, a process for applying a worker assignment rule change so as to preferentially assign workers whose working time is relatively short to a process step of a delivery-deadline-overdue product if the delivery deadline compliance evaluation value has not reached a target value, and preferentially assign workers whose working time is relatively long to a process step of a delivery-deadline-compliant product if the worker training evaluation value has not reached a target value, and
wherein the display performs a process for displaying plural worker assignment schemes for comparison purposes by simultaneously displaying the delivery deadline compliance evaluation value and the worker training evaluation value, which are the processing results produced by the controller.

4. The worker assignment device according to claim 1, wherein the worker assignment priority change section performs a process for producing a delivery-deadline-overdue product having the minimum or maximum time overdue from a delivery deadline as a product for applying a worker assignment priority change.

5. The worker assignment device according to claim 1, wherein the worker assignment priority change section performs a process for producing a delivery-deadline-compliant product having the minimum or maximum time remaining before a delivery deadline as a product for applying a worker assignment priority change.

6. The worker assignment device according to claim 1, wherein the worker assignment priority change section performs a process for giving the highest assignment priority to a worker having the minimum or maximum working time in a process step of a product to be subjected to an assignment priority change.

7. The worker assignment device according to claim 1, wherein the worker assignment priority change section performs a process for extracting, in a process step of a product to be subjected to an assignment priority change, a worker having the highest assignment priority from workers whose working time is shorter or longer than the working time of workers assigned before an assignment priority change and giving the extracted worker higher assignment priority than the workers assigned before the assignment priority change.
